(19) United States
(12) Patent Application Publication
(10) Pub. No.: US 2023/0243005 A1
(43) Pub. Date: Aug. 3, 2023

(54) CONVERTER BLOWING CONTROL METHOD AND CONVERTER BLOWING CONTROL SYSTEM

(71) Applicant: JFE Steel Corporation, Tokyo (JP)

(72) Inventors: Tomohiro Sugino, Tokyo (JP); Yukio Takahashi, Tokyo (JP); Shota Amano, Tokyo (JP); Ryo Kawabata, Tokyo (JP); Naoki Kikuchi, Tokyo (JP); Harutaka Chatani, Tokyo (JP); Toshiki Nonaka, Tokyo (JP)

(21) Appl. No.: 18/011,747

(22) PCT Filed: Apr. 30, 2021
(86) PCT No.: PCT/JP2021/017239

§ 371 Date: Dec. 20, 2022

(30) Foreign Application Priority Data
Jul. 1, 2020 (JP) 2020-113970

(51) Int. Cl. C21C 5/30; C21C 5/46

(52) U.S. Cl. CPC C21C 5/30; C21C 5/4673

(57) ABSTRACT

A converter blowing control method includes: calculating, by heat balance calculation and material balance calculation, an amount of oxygen to be supplied and an amount of a cooling material or a rising heat material to be charged for controlling a temperature and a component concentration of molten steel at end of blowing in a converter to target values; and controlling the blowing in the converter based on the calculated amount of oxygen to be supplied and the calculated amount of a cooling material or a rising heat material to be charged. A temperature of molten iron is used as a raw material for blowing, which is a target of the heat balance calculation, is used as a charged molten iron temperature used in the heat balance calculation, the temperature of molten iron being measured during a period when the molten iron is charged into the converter.

### TECHNICAL FIELD

This disclosure relates to a converter blowing control method and a converter blowing control system for controlling the temperature and component concentration of molten steel at the end of blowing to target values.

### BACKGROUND

The converter operation is a steelmaking process of obtaining molten steel by supplying oxygen to main raw materials including molten iron, scrap or the like charged into a converter to perform oxidation refining (blowing). In the converter operation, blowing control combining static control and dynamic control is performed to control the temperature and component concentration such as carbon concentration of molten steel at the end of blowing (blowing stop) to target values. In the static control, a mathematical model based on heat balance and material balance is used to determine, before the start of blowing, an amount of oxygen to be supplied and an amount of a cooling material or rising heat material to be charged necessary to control the temperature and component concentration of the molten steel to target values. On the other hand, in the dynamic control, the temperature and component concentration of molten metal are measured using a sublance during blowing, and the amount of oxygen to be supplied and the amount of a cooling material or rising heat material to be charged determined in the static control are corrected based on a mathematical model based on the heat balance and the material balance and a reaction model. Then, in the dynamic control, the amount of oxygen to be supplied and the amount of a cooling material or rising heat material to be charged before blowing stop are finally determined and controlled.

In the blowing control combining the static control and the dynamic control, if an error in the static control is too large, it is difficult to correct the error in the dynamic control, which sometimes makes it impossible to control the temperature and component concentration of the molten steel in blowing stop to the target values. Accordingly, it is necessary to minimize the error in the static control. The mathematical model used for the static control includes two types of calculation: heat balance calculation and oxygen balance calculation. In the heat balance calculation, the amount of a cooling material or rising heat material to be charged is calculated such that the sum of heat input into the converter and the sum of heat output from the converter are equal.

A formula used for the heat balance calculation includes a heat input determination term, a heat output determination term, a cooling term or a rising heat term, an error term, and a temperature correction term by an operator. To reduce the error in the static control, it is necessary to perform the heat balance calculation by giving an appropriate value to each term of the formula, and a method of determining an appropriate value has been studied. For example, JP 2012-87345 A discloses a method of predicting, based on a cooling curve obtained from a surface temperature of an inner clad refractory of a converter measured by a radiation thermometer and time information, an amount of temperature drop of molten steel in the subsequent blowing and incorporating the amount into heat balance calculation in static control.

However, even when the method disclosed in JP '345 is applied, an error in the static control remains unresolved; therefore, the control accuracy of the temperature of molten steel in blowing stop is not noticeably increased. In addition, a method has also been proposed in which information obtained sequentially during blowing, before measurement by a sublance, e.g., exhaust gas information during blowing (exhaust gas flow rate and exhaust gas component), is utilized and reflected in the converter operation so that estimation accuracy of the temperature and component concentration of the molten steel by a mathematical model is enhanced. For example, JP 2012-117090 A discloses a method of utilizing exhaust gas information to estimate a decarbonize-oxygen efficiency attenuation constant and a maximum decarbonize-oxygen efficiency that characterize decarburization characteristics during blowing, and using the estimation result to estimate the temperature and carbon concentration of the molten steel. According to the method disclosed in JP '090, since reaction heat generated in the decarburization reaction is accurately reflected in the estimation of the temperature of the molten steel, the control accuracy of the temperature of the molten steel in blowing stop is increased. However, since there are other factors affecting the temperature of the molten steel except for the decarburization reaction, the control accuracy of the temperature of the molten steel in blowing stop still did not reach a satisfactory level.

It could therefore be helpful to provide a converter blowing control method and a converter blowing control system capable of accurately controlling the temperature of molten steel at the end of blowing to a target value.

### SUMMARY

A converter blowing control method includes: calculating, by heat balance calculation and material balance calculation, an amount of oxygen to be supplied and an amount of a cooling material or a rising heat material to be charged to control a temperature and a component concentration of molten steel at end of blowing in a converter to target values; and controlling the blowing in the converter based on the calculated amount of oxygen to be supplied and the calculated amount of a cooling material or a rising heat material to be charged, wherein a temperature of molten iron is used as a raw material for blowing, which is a target of the heat balance calculation, is used as a charged molten iron temperature used in the heat balance calculation, the temperature of molten iron being measured during a period when the molten iron is charged into the converter.

A converter blowing control method includes: sequentially estimating a temperature and a component concentration of molten metal at progress of blowing by sequentially performing heat balance calculation and material balance calculation during the blowing based on operation conditions and a measured value of a converter obtained at start of and during the blowing in the converter; and controlling the blowing in the converter based on the estimated temperature and the estimated component concentration of the molten metal, wherein a temperature of molten iron used as a raw material for blowing, which is a target of the heat balance calculation, is used as a charged molten iron temperature used in the heat balance calculation, the temperature of molten iron being measured during a period when the molten iron is charged into the converter.

A temperature of molten iron used as a raw material for blowing, which is a target of the heat balance calculation, may be used as the charged molten iron temperature used in the heat balance calculation, the temperature of molten iron being measured by a non-contact optical method when the molten iron flows into the converter from a molten iron holding container.

The non-contact optical method may be a method of measuring an emission spectrum emitted from the molten iron to calculate a temperature of the molten iron from a radiation energy ratio of two different wavelengths selected from the measured emission spectrum.

λ1 and λ2 may both be 400 nm to 1000 nm and an absolute value of a difference between λ1 and λ2 is 50 nm or more and 600 nm or less, where the two different wavelengths are λ1 and λ2 (>λ1).

λ1 and λ2 may both be 400 nm to 1000 nm and an absolute value of a difference between λ1 and λ2 is 200 nm or more and 600 nm or less, where the two different wavelengths are λ1 and λ2 (>λ1).

A measured value of the temperature of the molten iron may be corrected based on a predetermined ratio of emissivity of emission spectra of the two different wavelengths.

A converter blowing control system includes: a temperature measuring device configured to optically measure, as a charged molten iron temperature, a temperature of molten iron used as a raw material for blowing in a converter during a period when the molten iron is charged into the converter; a computer configured to use the charged molten iron temperature measured by the temperature measuring device to calculate, by heat balance calculation and material balance calculation, an amount of oxygen to be supplied to the converter and an amount of a cooling material or a rising heat material to be charged into the converter to control a temperature and a component concentration of molten steel at end of the blowing in the converter to target values; and a control device configured to control the blowing in the converter based on the amount of oxygen to be supplied to the converter and the amount of a cooling material or a rising heat material to be charged into the converter calculated by the computer.

A converter blowing control system includes: a spectroscopic camera configured to measure temperature information measured by two-color thermometer of molten iron used as a raw material for blowing in a converter during a period when the molten iron is charged into the converter; a first computer configured to use the temperature information measured by two-color thermometer measured by the spectroscopic camera to calculate a temperature of the molten iron as a charged molten iron temperature; a second computer configured to use the charged molten iron temperature calculated by the first computer to calculate, by heat balance calculation and material balance calculation, an amount of oxygen to be supplied to the converter and an amount of a cooling material or a rising heat material to be charged into the converter for controlling a temperature and a component concentration of molten steel at end of the blowing in the convert-er to target values; and a control device configured to control the blowing in the converter based on the amount of oxygen to be supplied to the converter and the amount of a cooling material or a rising heat material to be charged into the converter calculated by the second computer.

A converter blowing control system includes: a temperature measuring device configured to optically measure, as a charged molten iron temperature, a temperature of molten iron used as a raw material for blowing in a converter during a period when the molten iron is charged into the converter; a computer configured to use the charged molten iron temperature measured by the temperature measuring device to sequentially calculate a temperature of molten steel during the blowing; and a control device configured to control the blowing in the converter based on the temperature of the molten steel during the blowing calculated by the computer.

A converter blowing control system includes: a spectroscopic camera configured to measure temperature information measured by two-color thermometer of molten iron used as a raw material for blowing in a converter during a period when the molten iron is charged into the converter; a first computer configured to use the temperature information measured by two-color thermometer measured by the spectroscopic camera to calculate a temperature of the molten iron as a charged molten iron temperature; a second computer configured to use the charged molten iron temperature calculated by the first computer to sequentially calculate a temperature of molten steel during the blowing; and a control device configured to control the blowing in the converter based on the temperature of the molten steel during the blowing calculated by the second computer.

According to our converter blowing control method and our converter blowing control system, the temperature of molten steel at the end of blowing can be accurately controlled to a target value.

### BRIEF DESCRIPTION OF THE DRAWINGS

FIG. 1 is a schematic diagram illustrating a configuration of a converter blowing control system according to an Example.

FIG. 2 is a diagram illustrating an example of a relationship between an elapsed time from measurement of a temperature of molten iron filled in a charging ladle using a thermocouple to measurement, using a two-color thermometer, of a temperature of the molten iron for flowing the molten iron into a converter from the charging ladle and a difference between the temperature of the molten iron measured by the two-color thermometer and the temperature of the molten iron measured by the thermocouple.

FIG. 3 is a diagram illustrating a relationship between an intermediate estimated temperature and an intermediate actual temperature in an Example and a Comparative Example in blowing 300 to 350 tons of molten iron using a 350-ton converter.

FIG. 4 is a diagram illustrating a temperature error of molten iron with respect to a target value at the end of blowing in an Example and a Comparative Example in blowing 300 to 350 tons of molten iron using a 350-ton converter.

### REFERENCE SIGNS LIST

1 CONVERTER BLOWING CONTROL SYSTEM
2 SPECTROSCOPIC CAMERA
3 FIRST COMPUTER
4 EXHAUST GAS FLOW METER
5 EXHAUST GAS ANALYZER
6 SECOND COMPUTER
7 CONTROL DEVICE
7a GAS FLOW RATE CONTROL DEVICE
7b SUBLANCE CONTROL DEVICE
7c AUXILIARY RAW MATERIALS CHARGING CONTROL DEVICE
11 CONVERTER
12 MOLTEN IRON
13 CHARGING LADLE

### DETAILED DESCRIPTION

Hereinafter, our converter blowing control methods and converter blowing control systems will be described.

### Converter Blowing Control Method

In the converter operation, blowing control combining static control and dynamic control is performed to control the temperature and component concentration such as carbon concentration of molten steel at the end of blowing (blowing stop) to target values. In the static control, a mathematical model based on heat balance calculation and material balance calculation is used to determine, before the start of blowing, an amount of oxygen to be supplied and an amount of a cooling material and rising heat material to be charged (hereinafter, referred to as a cooling material and so on) necessary to control the temperature and component concentration of the molten steel to target values. Then, the blowing is started and progressed based on the determined amount of oxygen to be supplied and the determined amount of a cooling material and so on to be charged, and the blowing is continued for a certain period of time (for example, a time point at which 80 to 90% of the amount of oxygen to be supplied calculated in the static control is blown, and the like), and then the temperature and component concentration of the molten metal are measured using a sublance. In the dynamic control, a mathematical model based on the temperature and component concentration of the molten metal measured using the sublance, the heat balance, the material balance, and the reaction model is used to correct the amount of oxygen to be supplied and the amount of a cooling material and so on to be charged that are determined in the static control, and the amount of oxygen to be supplied and the amount of a cooling material and so on to be charged before blowing stop are determined finally.

A calculation formula used for the heat balance calculation in the static control includes, for example, a heat input determination term, a heat output determination term, a cooling term or a temperature-rising term, an error term, and a temperature correction term by an operator. Among them, the heat input determination term includes a term representing sensible heat of the molten iron to be charged. Even in the method disclosed in JP '090 described above, the point that sensible heat of the molten iron to be charged needs to be given as an initial value is similar to the blowing control method combining the static control and the dynamic control.

The sensible heat of the molten iron to be charged is calculated by a formula of (specific heat of molten iron)×(mass of molten iron to be charged)×(temperature of molten iron to be charged). As the specific heat of molten iron, a physical property value described in a handbook or the like is used. As the mass of molten iron to be charged, for example, a difference between the weight of a charging ladle (molten iron holding container) filled with the molten iron measured by a load cell or the like before the molten iron is charged and the weight of an empty charging ladle measured by a load cell or the like after the molten iron is charged is used. Further, as the temperature of molten iron to be charged (charged molten iron temperature), a value measured by immersing a thermocouple in molten iron filled in the charging ladle is used, for example.

After diligent studies, we found that a reason why the control accuracy of temperature of molten steel in blowing stop is not increased is that a value of the sensible heat of the molten iron to be charged is inaccurate in the heat balance calculation in the static control and the dynamic control. In particular, we found that, when the sensible heat of the molten iron to be charged is calculated, it is not always appropriate to use a measured value of the temperature of the molten iron described above.

Generally, the temperature of molten iron is measured after the molten iron is charged into a charging ladle and slag is removed. However, after the temperature measurement, an elapsed time before the molten iron is charged into the converter greatly varies depending on the operation state of the converter and steelmaking process after the converter. For example, after the temperature of the molten iron is measured, the molten iron is immediately charged into the converter to start blowing in some instances, or after the temperature of the molten iron is measured, it may be forced to wait until the molten iron is charged into the converter in a state where the molten iron is filled in the charging ladle as it is. That is, since an amount of temperature drop of the molten iron in a period from when the temperature of the molten iron is measured to when the molten iron is charged into the converter is different, the actual charged molten iron temperature is also different.

In particular, if the waiting time until the molten iron is charged into the converter is long, the temperature distribution of the molten iron occurs in the depth direction of the charging ladle due to heat convection. In a charging ladle with a loading weight of more than 200 tons, the depth of a molten iron bath when filled with molten iron is on the order of several meters, whereas the depth of immersion of the thermocouple at the time of temperature measurement is several tens of centimeters. For this reason, even if the temperature of the molten iron is measured again in the charging ladle before the molten iron is charged into the converter, the influence of the temperature distribution of the molten iron is not sufficiently reflected in the temperature measurement value, which causes an error. The state of the charging ladle used also affects the amount of temperature drop of the molten iron in the period from when the temperature of the molten iron is measured to when the molten iron is charged into the converter. For example, a charging ladle having a high ratio of a ladle filled time (time in the state of being filled with the molten iron within a certain period) has a small amount of temperature drop of the molten iron, and conversely, a charging ladle having a low ratio of the ladle filled time has a large amount of temperature drop of the molten iron.

Further, in recent years, when two converters are used, one of the converters performs a desiliconization treatment or a dephosphorization treatment (a desiliconization/dephos-phorization furnace), and the other converter performs a decarburization treatment (a decarburi-zation furnace). In such an operation mode, molten iron that has been treated in the desiliconiza-tion/dephosphorization furnace is received in a charging ladle on standby under the furnace, and the molten iron received in the charging ladle is charged into the decarburization furnace to perform a decarburization treatment. The static control and the dynamic control described above are also performed in the decarburization treatment, and as the charged molten iron temperature in the heat balance calculation, a molten iron temperature measured in the converter at the end of the desiliconization/dephosphorization treatment or during tapping, or a temperature obtained by correcting the molten iron temperature measured in the converter at the end of the desiliconization/dephosphorization treatment or during tapping with the amount of temperature drop of the molten iron during tapping, or the like is used. However, even in that instance, the problem is the same as described above, for example, a time from tapping to charging greatly varies depending on the operation state.

As described above, we found that there is a situation where a value of the temperature of the molten iron used to calculate the sensible heat of the molten iron to be charged is not necessarily appropriate at present. However, it is difficult to perform the operation while keeping constant the elapsed time before the molten iron is charged into the converter after the temperature of the molten iron is measured. In light of the above, we used, as the charged molten iron temperature used for heat balance calculation, a temperature of the molten iron measured during a period in which the molten iron used as a raw material for blowing, which is a target of the heat balance calculation, is charged into the converter. This increases the accuracy of heat balance calculation as compared with the related art and enables the temperature of the molten steel to be accurately controlled to a target value.

As the charged molten iron temperature, it is preferable to use the temperature of the molten iron measured by a non-contact optical method when the molten iron used as a raw material for blowing, which is a target of the heat balance calculation, flows into the converter from the charging ladle. The temperature of the molten iron is measured at this timing to obtain a measured value after the influence of the waiting time in the charging ladle or the like is reflected so that the problem described above is solved. As the method of temperature measurement, a method of measuring by immersing a thermocouple or the like in an injection flow when the molten iron flows into the converter from the charging ladle is possible. However, large-scale equipment is required to immerse the thermocouple in the injection flow. Accordingly, it is preferable to use a non-contact optical method with which the temperature can be measured more easily.

Examples of the non-contact optical method include a temperature measurement method using a two-color thermometer, a radiation thermometer, a thermoviewer or the like. In addition, when a temperature is measured by the non-contact optical method, it may be difficult to measure the temperature accurately because slag floats on the bath surface in the molten iron in a stationary state filled in the charging ladle. On the other hand, when measurement is performed on an injection flow at the time of flowing into the converter from the charging ladle, the surface of the molten iron is partly exposed so that more accurate measurement can be performed.

Among the non-contact optical methods described above, a method of measuring an emission spectrum emitted from the molten iron and calculating a temperature from a radiation energy ratio of two different wavelengths selected from the obtained emission spectrum, that is, a method using a two-color thermometer is more preferable. There is a possibility that the emissivity of the injection flow at the time of flowing into the converter from the charging ladle, which is a target of the temperature measurement, varies depending on the measurement conditions. This is because, in the method using the two-color thermometer, even when the emissivity of the temperature measurement target varies, as long as a relationship between the two spectral emissivity having different wavelengths varies while maintaining a proportional relationship, the ratio of the two spectral emissivity depends only on the temperature so that accurate temperature measurement can be performed regardless of the variation in emissivity.

Assuming that the two different wavelengths are λ1 and λ2 (λ1<λ2), it is preferable to select the wavelengths such that λ1 and λ2 satisfy the following relationship. Specifically, it is preferable that λ1 and λ2 are both 400 nm to 1000 nm and the absolute value of the difference between λ1 and λ2 is 50 nm or more and 600 nm or less. Even in the method using the two-color thermometer, a measurement error occurs when the emissivity of two emission spectra having different wavelengths do not vary while maintaining a proportional relationship with each other. For high-precision measurement, it is desirable to select a condition to reduce the variations in emissivity ratio R (R=ε_{λ1}/ε_{λ2}), which is the ratio of the emissivity ε_{λ1} and ε_{λ2} of two emission spectra having different wavelengths. We believe that the influence of stray light from an oxide film on the surface of the molten iron or the furnace wall, which is a factor of the variations in emissivity ratio R, is large on the long wavelength side where the emissivity is relatively small. Therefore, it is preferable to select the detection wavelength on the short wavelength side where the emissivity is large.

Specifically, it is preferable to select both λ1 and λ2 within 400 nm to 1000 nm. When the wavelength is less than 400 nm, it is difficult for an ordinary spectroscopic camera to detect radiation energy because the wavelength is short. On the other hand, when the wavelength exceeds 1000 nm, the wavelength is long, and thus the influence of variations in emissivity ratio increases. Further, the absolute value of the difference between λ1 and λ2 is preferably 50 nm or more and 600 nm or less. When the absolute value of the difference between λ1 and λ2 is less than 50 nm, the wavelengths of λ1 and λ2 are close to each other, and thus, it is difficult to perform spectroscopy with an ordinary spectroscopic camera. On the other hand, when the absolute value of the difference between λ1 and λ2 exceeds 600 nm, one wavelength is inevitably selected from the condition of long wavelength, and the influence of variations in emissivity ratio increases because of the long wavelength.

When the absolute value of the difference between λ1 and λ2 is 200 nm or more and 600 nm or less, the influence of variations in emissivity ratio R is reduced, which is more preferable. In addition, the emissivity ratio R may be determined in advance based on experiments or literature values, and the measured value of the temperature of the molten iron may be corrected with the emissivity ratio R determined in advance. However, even if the measured value of the temperature of the molten iron is corrected with the predetermined emissivity ratio R to reduce measurement errors, a measurement error may occur. For example, the intensity of light emitted from the molten iron is attenuated by soot and smoke generated by a reaction between the molten iron and oxygen in the atmosphere at the time of molten iron charging. When the attenuation rate of emitted light varies depending on the measured wavelength, the radiation energy ratio I(λ1)/I(λ2) between λ1 and λ2 changes, which causes a measurement error. It is difficult to reduce the soot and smoke, and the concentration and occurrence frequency thereof cannot be predicted and thus it is difficult to take the influence of the soot and smoke into consideration with high accuracy by correction in advance. Further, sparks, flames and the like generated while the molten iron is charged may also have an influence similar to the soot and smoke.

We therefore considered measures to reduce the influence of the soot and smoke described above and enable more accurate temperature measurement. Specifically, we focused on the fact that when the soot and smoke are measured, the radiation energy varies greatly depending on the wavelength in the wavelength range of 400 to 1000 nm. Then, upper and lower limit thresholds were set for each of the radiation energies I(λ1) and I(λ2) of λ1 and λ2, and the measured radiation energy value was used for calculation of the temperature only when I(λ1) and I(λ2) fall within the range of the upper and lower limit thresholds. As a result, it is possible to reduce the influence of attenuation of the radiation intensity due to soot and smoke and the influence of an increase in radiation intensity due to flame, and to perform temperature measurement with higher accuracy.

The upper and lower limit thresholds of the radiation energy may be determined as follows, for example. To be specific, molten metal having a known temperature T₀ is prepared in advance by experimental equipment or the like, and a spectroscopic camera is used to measure a radiation energy value (I′(λ1)_{T0}, I′(λ2)_{T0}) of a wavelength to be measured (λ1, λ2) at the temperature T₀. For example, when the range of the molten metal temperature to be measured is 1200 to 1350° C., I′(λ1)₁₂₀₀ and I′(λ2)₁₂₀₀ at 1200° C. are measured in advance, and the measured values are set as the lower limit values of I(λ1) and I(λ2) in actual measurement. Similarly, I′(λ1)₁₃₅₀ and I′(λ2)₁₃₅₀ at 1350° C. are measured in advance, and the measured values are set as the upper limit values of I(λ1) and I(λ2) in actual measurement.

The lower limit values of I(λ1) and I(λ2) may be values of I′(λ1)_{Tmin} and I′(λ2)_{Tmin} obtained in advance with T₀ as the minimum temperature Tₘᵢₙ in a range of temperature to be measured. Alternatively, Tₘᵢₙ may be set to a temperature lower than the minimum temperature by about 50° C. or less in consideration of the amount of temperature drop while the molten iron is charged. In general, since the radiation energy value decreases as the temperature decreases, the values of I′(λ1)_{T0} and I′(λ2)_{T0} at a temperature lower than the above temperature are too small to function as thresholds. On the other hand, the upper limit values of I(λ1) and I(λ2) may be values of I′(λ1)_{Tmax}, I′(λ2)_{Tmax} obtained in advance with T₀ as the maximum temperature Tₘₐₓ in the range of temperature to be measured. The reason why the upper limit value is provided is that since the value of the radiation energy generated by sparks and flames is generally large, the influence of sparks and flames in the measured value is relatively large, and the accuracy as the measured value of the molten iron temperature is reduced.

### Converter Blowing Control System

A converter blowing control system according to a first example includes: a temperature measuring device that optically measures, as a charged molten iron temperature, a temperature of molten iron during a period when the molten iron used as a raw material for blowing in a converter is charged into the converter; a computer that uses the charged molten iron temperature measured by the temperature measuring device to calculate an amount of oxygen to be supplied and an amount of a cooling material and so on to be charged for controlling a component and temperature of molten steel at the end of the blowing to target values; and a control device that controls the blowing in the converter based on the amount of oxygen to be supplied to the converter and the amount of cooling material and so on to be charged into the converter calculated by the computer.

The computer may use the charged molten iron temperature measured by the temperature measuring device to sequentially calculate the temperature of molten metal during the blowing, and the control device may control the blowing in the converter based on the temperature of the molten metal during the blowing calculated by the computer.

Examples of the temperature measuring device include a two-color thermometer, a radiation thermometer, and a thermoviewer. The temperature measuring device is installed, for example, in a place where an injection flow of the molten iron flowing into the converter from the charging ladle can be observed. It is preferable to install the temperature measuring device at an angle at which the injection flow is looked up because the temperature measuring device is hardly affected by dust when the molten iron is charged. The temperature measuring device measures the temperature of the molten iron at a preset timing or period between the start and the end of charging of the molten iron. The temperature of the molten iron measured by the temperature measuring device is transmitted to a computer installed in an operation room or the like, and the computer executes blowing calculation such as static control calculation using the received molten iron temperature as the charged molten iron temperature.

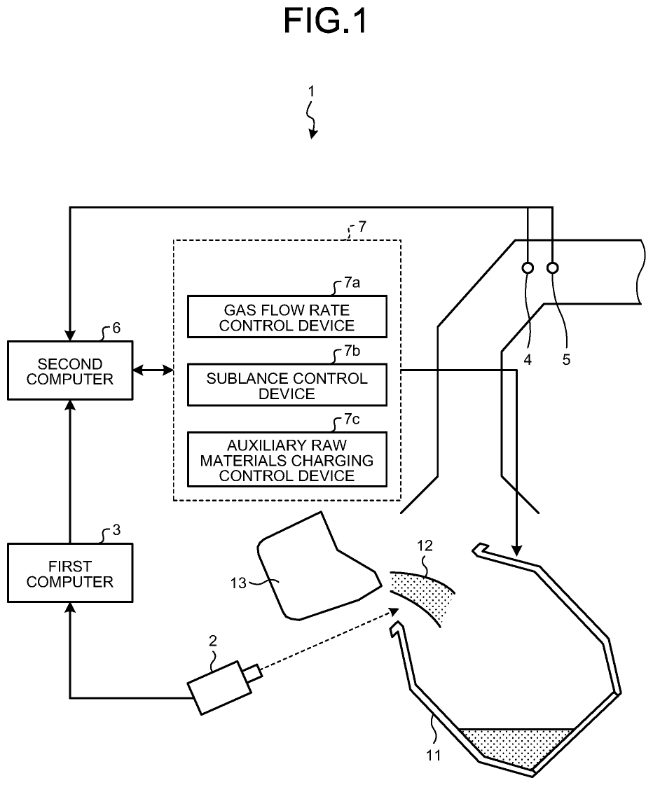

As illustrated in FIG. 1, a converter blowing control system 1 according to a second example includes: a spectroscopic camera 2 that measures temperature information measured by two-color thermometer of molten iron 12 used as a raw material for blowing in a converter 11 during a period when the molten iron 12 is charged into the converter 11 from a charging ladle 13; a first computer 3 that receives the temperature information measured by two-color thermometer from the spectroscopic camera 2 and calculates a charged molten iron temperature; an exhaust gas flowmeter 4 that measures the flow rate of exhaust gas from the converter 11; an exhaust gas analyzer 5 that analyzes the composition of the exhaust gas from the converter 11; a second computer 6 that calculates an amount of oxygen to be supplied and an amount of a cooling material and so on to be charged for controlling the component and temperature of molten steel at the end of blowing using the charged molten iron temperature calculated by the first computer 3, the flow rate of exhaust gas measured by the exhaust gas flowmeter 4, and the composition of the exhaust gas analyzed by the exhaust gas analyzer 5, and a control device 7 that controls the blowing in the converter 11 based on the amount of oxygen to be supplied to the converter 11 and the amount of the cooling material and so on to be charged into the converter 11 calculated by the second computer 6.

The control device 7 includes a gas flow rate control device 7a that controls the flow rate of gas such as oxygen to be supplied to the converter 11, a sublance control device 7b that controls the operation of measuring the temperature and component concentration of the molten metal using the sublance, and an auxiliary raw materials charging control device 7c that controls the operation of charging an auxiliary raw material into the converter 11. The second computer 6 may sequentially calculate the temperature of the molten metal during blowing using the charged molten iron temperature calculated by the first computer 3, the flow rate of exhaust gas measured by the exhaust gas flowmeter 4, and the composition of exhaust gas analyzed by the exhaust gas analyzer 5, and the control device 7 may control blowing in the converter 11 based on the temperature of the molten metal during blowing calculated by the second computer 6.

The spectroscopic camera 2 is a general term for cameras capable of capturing spectroscopic data in addition to a planar image of a measured temperature such as a so-called thermoviewer. In addition, the spectroscopic data is data collected by dividing a large number of wavelengths contained in emitted light for each wavelength. As a method of measuring the temperature information measured by two-color thermometer by the spectroscopic camera 2, a large number of wavelength data may be collected by the spectroscopic camera 2, and data of arbitrary two wavelengths may be extracted, by a computer or the like, from the obtained data, or, alternatively, if the camera has a bandpass filter in the spectroscopic camera 2, arbitrary two wavelengths may be extracted by the bandpass filter. In addition, most spectroscopic camera capturing is performed by a CCD element. However, a plurality of CCD elements may be mounted, and the individual CCD elements may measure wavelength ranges different from one another. As the spectroscopic camera 2, it is more preferable to adopt a type (line measurement) having a linear region as a measurement point, rather than a type (spot measurement) having a dotted region as a measurement point. Since the exposed position always moves in the injection flow at the time of molten iron charging, accurate measurement cannot be performed in the spot measurement type in some instances. On the other hand, in the line measurement type, spectrum measurement of the injection flow is performed at a plurality of positions, which enables accurate measurement with high probability. When a spectroscopic camera of the line measurement type is used, a representative value can be obtained by taking the average of the measured values in the measurement region.

The spectroscopic camera 2 is installed, for example, in front of the furnace on the converter charging side, at a place where an injection flow when the molten iron 12 flows into the converter 11 from the charging ladle 13 can be observed. It is preferable to install the spec-troscopic camera 2 at an angle at which the injection flow is looked up because the spectroscopic camera 2 is hardly affected by dust when the molten iron is charged. When the spectroscopic camera 2 is installed above the injection flow at the time of molten iron charging, the amount of soot and smoke between the spectroscopic camera and the injection flow increases because the soot and smoke rises, leading to increase in measurement error. Usually, an operating floor on which an operation room is provided is located below the position of the injection flow at the time of molten iron charging and thus the spectroscopic camera 2 is preferably installed on the operating floor. Further, it is more preferable that the installation location of the spectroscopic camera 2 is a point which is located below the injection flow at the time of molten iron charging and is moved by 5 to 15° in the horizontal direction from a line connecting the centers of the converter and the charging ladle in the horizontal direction with a position where the furnace throat of the converter and an opening of the charging ladle are aligned at the time of molten iron charging as a starting point. The angles of the converter and the charging ladle while the molten iron is charged change with the progress of the molten iron charging and thus the field of view in which the injection flow can be observed also changes. On the other hand, from the viewpoint of improvement in measurement precision and measurement accuracy and simplification of measuring device, it is preferable that measurement can be conducted with the field of view of the spectroscopic camera 2 fixed while the molten iron is charged.

For example, when the spectroscopic camera is disposed at a position perpendicular to the line connecting the centers of the converter and the charging ladle in the horizontal direction, the injection flow relatively largely moves up, down, left, and right in the field of view of the spectroscopic camera 2 as the molten iron charging proceeds. On the other hand, when the spectroscopic camera 2 is disposed at a position relatively close to the converter on the line connecting the centers of the converter and the charging ladle in the horizontal direction, the injection flow does not move much in the field of view of the spectroscopic camera 2. However, when the spectroscopic camera 2 is close to the converter, the spectroscopic camera 2 cannot withstand heat, and when the spectroscopic camera 2 is far from the converter, the field of view of the spectroscopic camera 2 is blocked by the converter or the charging ladle, thus the injection flow cannot be measured. In light of the above, it is preferable that the installation location of the spectroscopic camera 2 is a point which is located below the injection flow at the time of molten iron charging and is moved by 5 to 15° in the horizontal direction from the line connecting the centers of the converter and the charging ladle in the horizontal direction. The spectroscopic camera 2 is preferably separated from the converter by about 20 m or more. This is because if the distance from the converter is shorter than 20 m, then high-temperature molten material scattered from the converter during charging or blowing may come into contact with the spectroscopic camera 2, which may damage the spectroscopic camera 2.

In the spectroscopic camera 2, temperature information measured by two-color thermometer is collected at a preset sampling rate (for example, every second) from the start to the end of molten iron charging. The temperature information measured by two-color thermometer collected by the spectroscopic camera 2 is transmitted to the first computer 3 installed in an operation room or the like, and the first computer 3 calculates the charged molten iron temperature. A blowing calculation such as a static control calculation is performed using the calculated charged molten iron temperature. The first computer 3 calculating the charged molten iron temperature and the second computer 6 performing the blowing calculation may be the same computer or different computers.

### Examples

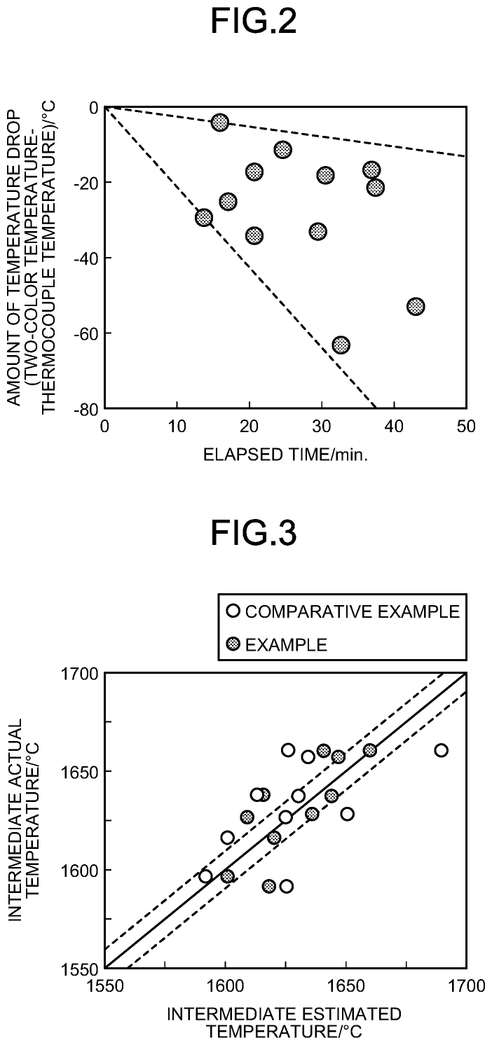

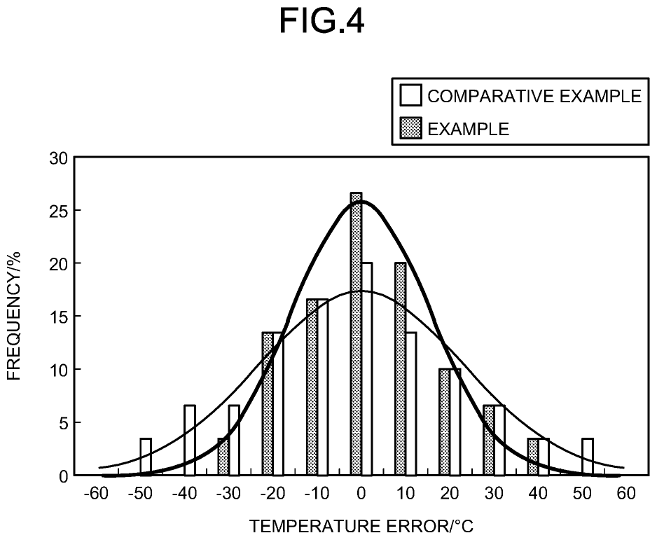

FIG. 2 is a diagram illustrating an example of a relationship between an elapsed time from measurement of a temperature of molten iron filled in a charging ladle using a thermocouple to measurement, using a two-color thermometer, of a temperature of molten iron for flowing into a converter from the charging ladle and a difference (temperature difference) between the temperature of molten iron measured by the two-color thermometer and the temperature of molten iron measured by the thermocouple. As illustrated in FIG. 2, there is a correlation between the temperature difference and the elapsed time, but there is a large variation. To be specific, since a change amount of the temperature of the molten iron varies before the molten iron is charged into the converter after the temperature of the molten iron is measured in the charging ladle, it can be seen that the use of the temperature of the molten iron measured in the charging ladle as the charged molten iron temperature for heat balance calculation causes a decrease in accuracy of the heat balance calculation.

FIG. 3 is a diagram illustrating a relationship between a temperature (intermediate estimated temperature) of the molten metal during blowing estimated from the operation conditions and the exhaust gas information and a temperature (intermediate actual temperature) of the molten metal measured by the sublance charged during blowing in an Example and a Comparative Example in blowing 300 to 350 tons of molten iron using a 350-ton converter. The example shows an intermediate estimated temperature when the temperature of the molten iron during charging is reflected in the heat balance calculation as the charged molten iron temperature, and the Comparative Example shows an intermediate estimated temperature calculated using the charged molten iron temperature estimated from the temperature at the end of the preceding process (dephosphorization treatment in the converter) and an estimated amount of temperature drop. As illustrated in FIG. 3, it can be seen that a difference between the intermediate estimated temperature and the intermediate actual temperature is smaller in the Example than in the Comparative Example. As a result, we confirmed that the accuracy of the heat balance calculation is improved by reflecting the temperature of the molten iron during charging in the heat balance calculation as the charged molten iron temperature.

Table 1 shown below indicates an error of an actual molten steel temperature with respect to a target molten steel temperature at the end of blowing in an Example and a Comparative Example in blowing 300 to 350 tons of molten iron using a 350-ton converter. As with the example illustrated in FIG. 3, the Example is when the temperature of the molten iron measured while the molten iron is charged is reflected in the heat balance calculation as the charged molten iron temperature, and the Comparative Example is when the charged molten iron temperature estimated from the temperature at the end of the preceding process and the estimated amount of temperature drop is used. As shown in Table 1, an intermediate sublance temperature can be controlled in a narrow range by reflecting the molten iron temperature measured while the molten iron is charged in the heat balance calculation, leading to improvement in accuracy of the molten steel temperature at the time of blowing stop. That is, it was confirmed that the molten steel temperature at the end of blowing can be accurately controlled by reflecting the temperature of the molten iron measured while the molten iron is charged as the charged molten iron temperature in the heat balance calculation.

TABLE 1

| | | | | | Variation in final |
|---|---|---|---|---|---|
| | | Temperature | Intermediate | Final target | actual temperature |
| | Number of | measurement at | sublance | temperature | relative to final |
| | charges | time of charging | temperature (° C.) | (° C.) | target temperature 1σ |
| Comparative | 50 | Not measured | 1540 to 1700 | 1660 to 1720 | 23.0 |
| Example | | | | | |
| Example | 50 | Measured | 1560 to 1680 | 1660 to 1720 | 15.4 |

Although the examples to which our systems and methods are applied have been described above, this disclosure is not limited by the description and drawings constituting a part of the disclosure according to the examples. That is, other configurations, examples, operation techniques and the like made by those skilled in the art based on the examples are all included in the scope of this disclosure.

### INDUSTRIAL APPLICABILITY

It is possible to provide the converter blowing control method and the converter blowing control system capable of accurately controlling the temperature of molten steel at the end of blowing to a target value.

1-11. (canceled)

12. A converter blowing control method comprising:
calculating, by heat balance calculation and material balance calculation, an amount of oxygen to be supplied and an amount of a cooling material or a rising heat material to be charged to control a temperature and a component concentration of molten steel at end of blowing in a converter to target values; and
controlling the blowing in the converter based on the calculated amount of oxygen to be supplied and the calculated amount of a cooling material or a rising heat material to be charged, wherein
a temperature of molten iron is used as a raw material for blowing, which is a target of the heat balance calculation, is used as a charged molten iron temperature used in the heat balance calculation, the temperature of molten iron being measured during a period when the molten iron is charged into the converter.

13. A converter blowing control method comprising:
sequentially estimating a temperature and a component concentration of molten metal at progress of blowing by sequentially performing heat balance calculation and material balance calculation during the blowing based on operation conditions and a measured value of a converter obtained at start of and during the blowing in the converter; and
controlling the blowing in the converter based on the estimated temperature and the estimated component concentration of the molten metal, wherein
a temperature of molten iron used as a raw material for blowing, which is a target of the heat balance calculation, is used as a charged molten iron temperature used in the heat balance calculation, the temperature of molten iron being measured during a period when the molten iron is charged into the converter.

14. The method according to claim 12, wherein a temperature of molten iron used as a raw material for blowing, which is a target of the heat balance calculation, is used as the charged molten iron temperature used in the heat balance calculation, the temperature of molten iron being measured by a non-contact optical method when the molten iron flows into the converter from a molten iron holding container.

15. The method according to claim 14, wherein the non-contact optical method is a method of measuring an emission spectrum emitted from the molten iron to calculate a temperature of the molten iron from a radiation energy ratio of two different wavelengths selected from the measured emission spectrum.

16. The method according to claim 15, wherein λ1 and λ2 are both 400 nm to 1000 nm and an absolute value of a difference between λ1 and λ2 is 50 nm or more and 600 nm or less, where the two different wavelengths are λ1 and λ2 (>λ1).

17. The converter blowing control method according to claim 15, wherein λ1 and λ2 are both 400 nm to 1000 nm and an absolute value of a difference between λ1 and λ2 is 200 nm or more and 600 nm or less, where the two different wavelengths are λ1 and λ2 (>λ1).

18. The method according to claim 15, further comprising correcting a measured value of the temperature of the molten iron based on a predetermined ratio of emissivity of emission spectra of the two different wavelengths.

19. A converter blowing control system comprising:
a temperature measuring device configured to optically measure, as a charged molten iron temperature, a temperature of molten iron used as a raw material for blowing in a converter during a period when the molten iron is charged into the converter;
a computer configured to use the charged molten iron temperature measured by the temperature measuring device to calculate, by heat balance calculation and material balance calculation, an amount of oxygen to be supplied to the converter and an amount of a cooling material or a rising heat material to be charged into the converter for controlling a temperature and a component concentration of molten steel at end of the blowing in the converter to target values; and
a control device configured to control the blowing in the converter based on the amount of oxygen to be supplied to the converter and the amount of a cooling material or a rising heat material to be charged into the converter calculated by the computer.

20. A converter blowing control system comprising:
a spectroscopic camera configured to measure temperature information measured by two-color thermometer of molten iron used as a raw material for blowing in a converter during a period when the molten iron is charged into the converter;
a first computer configured to use the temperature information measured by two-color thermometer measured by the spectroscopic camera to calculate a temperature of the molten iron as a charged molten iron temperature;
a second computer configured to use the charged molten iron temperature calculated by the first computer to calculate, by heat balance calculation and material balance calculation, an amount of oxygen to be supplied to the converter and an amount of a cooling material or a rising heat material to be charged into the converter for controlling a temperature and a component concentration of molten steel at end of the blowing in the converter to target values; and
a control device configured to control the blowing in the converter based on the amount of oxygen to be supplied to the converter and the amount of a cooling material or a rising heat material to be charged into the converter calculated by the second computer.

21. A converter blowing control system comprising:
a temperature measuring device configured to optically measure, as a charged molten iron temperature, a temperature of molten iron used as a raw material for blowing in a converter during a period when the molten iron is charged into the converter;
a computer configured to use the charged molten iron temperature measured by the temperature measuring device to sequentially calculate a temperature of molten steel during the blowing; and
a control device configured to control the blowing in the converter based on the temperature of the molten steel during the blowing calculated by the computer.

22. A converter blowing control system comprising:
a spectroscopic camera configured to measure temperature information measured by two-color thermometer of molten iron used as a raw material for blowing in a converter during a period when the molten iron is charged into the converter;
a first computer configured to use the temperature information measured by two-color thermometer measured by the spectroscopic camera to calculate a temperature of the molten iron as a charged molten iron temperature;
a second computer configured to use the charged molten iron temperature calculated by the first computer to sequentially calculate a temperature of molten steel during the blowing; and
a control device configured to control the blowing in the converter based on the temperature of the molten steel during the blowing calculated by the second computer.

23. The method according to claim 13, wherein a temperature of molten iron used as a raw material for blowing, which is a target of the heat balance calculation, is used as the charged molten iron temperature used in the heat balance calculation, the temperature of molten iron being measured by a non-contact optical method when the molten iron flows into the converter from a molten iron holding container.

24. The method according to claim 23, wherein the non-contact optical method is a method of measuring an emission spectrum emitted from the molten iron to calculate a temperature of the molten iron from a radiation energy ratio of two different wavelengths selected from the measured emission spectrum.

25. The method according to claim 24, wherein λ1 and λ2 are both 400 nm to 1000 nm and an absolute value of a difference between λ1 and λ2 is 50 nm or more and 600 nm or less, where the two different wavelengths are λ1 and λ2 (>λ1).

26. The method according to claim 24, wherein λ1 and λ2 are both 400 nm to 1000 nm and an absolute value of a difference between λ1 and λ2 is 200 nm or more and 600 nm or less, where the two different wavelengths are λ1 and λ2 (>λ1).

27. The method according to claim 24, comprising correcting a measured value of the temperature of the molten iron based on a predetermined ratio of emissivity of emission spectra of the two different wavelengths.
